(19) United States
(12) Patent Application Publication
(10) Pub. No.: US 2021/0350128 A1
(43) Pub. Date: Nov. 11, 2021

(54) SYSTEM AND METHOD FOR MANAGING AND PROCESSING AGRICULTURAL FIELD DATA

(71) Applicant: E. & J. Gallo Winery, Modesto, CA (US)

(72) Inventors: Alexander O'Brien, Modesto, CA (US); Timothy Kim, San Jose, CA (US); Devin Rocco, Mill Valley, CA (US); Paul Perrone, Riverbank, CA (US); Randal Jessee, Tracy, CA (US); Adam Irrer, Fairfax, CA (US); Ryan Barr, Modesto, CA (US)

(21) Appl. No.: 17/308,442

(22) Filed: May 5, 2021

Related U.S. Application Data
(60) Provisional application No. 63/021,397, filed on May 7, 2020.

(51) Int. Cl. G06K 9/00; G06F 9/38; G01W 1/10

(52) U.S. Cl. CPC G06K 9/00657; G01W 1/10; G06F 9/3877

(57) ABSTRACT

This disclosure relates to a platform for distributing information related to agricultural fields from a plurality of publishers to a plurality of subscribers. An example method includes: providing the platform to the publishers and the subscribers, wherein the publishers provide data to the platform related to agricultural fields, and wherein the subscribers receive data from the platform related to the agricultural fields; receiving publisher data including satellite image data, weather data, laboratory data, and/or sensor data for the agricultural fields; receiving a definition of a parcel of land in the agricultural fields; processing the publisher data to generate information related to a condition of the parcel of land in the agricultural fields; and providing the subscriber with the information related to the condition of the parcel of land in the agricultural fields.

### CROSS-REFERENCE TO RELATED APPLICATIONS

This application claims priority to and benefit of U.S. Provisional Application No. 63/021,397, filed on May 7, 2020, the entire disclosure of which is hereby incorporated by reference.

### TECHNICAL FIELD

The following disclosure relates to a platform for managing and processing information related to agricultural fields and, in certain examples, to a platform that allows a user to receive agricultural field data from a variety of sources and to manage agricultural fields based on such data.

### BACKGROUND

Information related to conditions in agricultural fields can be obtained from thousands of separate, disconnected, or unrelated sources in the agriculture technology industry, with each source having its own point solutions to specific target problems. Weather information can be obtained from one or more weather services, images of fields and/or plants can be obtained from cameras or image providers, test data can be obtained from consultants or laboratory service providers, and field sensor data can be obtained from other service providers or devices. Such information may be available online from each of these separate sources.

In many instances, however, growers or other individuals who need access to agricultural field information are in remote locations (e.g., in remote fields) and do not have Internet access, so obtaining information online may not be an option. Further, when Internet access is available, such individuals may be forced to visit multiple websites and/or access multiple software applications to search for and obtain the desired information. This leads to digital fatigue for growers trying to decide which sets of tools or services to use, and to remember to use them all.

There is a need for improved systems and methods for obtaining and distributing agricultural field information to growers and similar individuals in need of such information.

The foregoing discussion, including the description of motivations for some embodiments of the invention, is intended to assist the reader in understanding the present disclosure, is not admitted to be prior art, and does not in any way limit the scope of any of the claims.

### SUMMARY

In certain examples, this disclosure relates to a platform that enables users (also referred to as subscribers) to obtain information related to agricultural fields from a variety of information providers (also referred to as publishers). A subscriber can use the platform to define one or more properties (e.g., parcels of land or agricultural fields) associated with the subscriber and can choose services that the subscriber would like to receive from the platform for the one or more properties. The services can provide data or information related to, for example, images of the properties (e.g., satellite images or drone images), weather (e.g., current or predicted), plant health or condition, plant types, plant age, soil conditions, pest infestations, moisture levels, and/or similar information related to a condition in the one or more properties. The platform can receive the desired information from a plurality of publishers, such as, for example, image providers (e.g., satellite image providers or photographers), weather services, laboratories, Internet of things (IoT) devices or sensors (e.g., cameras, thermometers, soil sensors, rain gauges, etc.), harvesters, and/or labor management solutions. The publishers can be or include, for example, organizations (e.g., companies, businesses, and/or cloud-based service providers), individuals (e.g., a photographer, a chemist, a botanist, etc.), and/or devices (e.g., online sensors). The platform can send alerts or notifications to subscribers when problems are detected. The platform can recommend solutions to address the problems and/or can automatically take corrective action in a field location, with or without instructions from subscribers.

Advantageously, the platform can enable subscribers to access or view information from publishers using a single application, such as a web application or a mobile application associated with the platform. The single application can download information when Internet access is available and present the information to subscribers later, when Internet access may not be available. The platform allows growers to access solutions that rely on IoT devices or third party services that provide, for example, crop health imagery, irrigation scheduling, pest detection, work scheduling, equipment maintenance, and the like. The platform can provide a marketplace and integration for IoT and service vendors to place products to fulfill these solutions. A single platform for accessing numerous, otherwise disconnected services can eliminate friction associated with having to access or learn each service separately.

Further, the platform and related systems and methods described herein can achieve significant improvements to computer functionality. For example, by improving connections between subscribers and publishers, the platform enables subscribers to search for and retrieve publisher data more accurately and efficiently. A single platform can be used to access a wide variety of data sources, which is more efficient and accurate than having to access such sources individually. This can significantly reduce a number of operations and/or network hops required to access the desired information.

In general, in one aspect, the subject matter of this disclosure relates to a computer-implemented method. The method includes: providing a platform to a plurality of publishers and a plurality of subscribers, the plurality of publishers including one or more entities that provide data to the platform related to agricultural fields, the plurality of subscribers including one or more users who receive data from the platform related to the agricultural fields; receiving, from the plurality of publishers, publisher data including at least one of satellite image data, weather data, laboratory data, or sensor data for the agricultural fields; receiving, from a subscriber in the plurality of subscribers, a definition of a parcel of land in the agricultural fields; processing the publisher data to generate information related to a condition of the parcel of land in the agricultural fields; and providing, to the subscriber, the information related to the condition of the parcel of land in the agricultural fields.

In certain examples, the one or more entities can include a satellite image provider, a weather data provider, a laboratory data provider, and/or a sensor. The one or more users can access the platform using one or more respective client devices. The definition of the parcel of land can include a definition of a boundary for the parcel of land. The satellite image data can include satellite images having color and near infrared information. The weather data can include current weather conditions and/or predicted weather conditions. The sensor data can be obtained from at least one Internet of things device installed in the agricultural fields.

In some implementations, processing the publisher data can include: calculating a normalized difference vegetation index (NDVI) from a satellite image of the parcel of land; and modifying the satellite image to include colors representing the NDVI values in the parcel of land. Providing the information can include providing the modified satellite image for presentation on a client device of the subscriber. Providing the information can include providing the information to a client device of the subscriber, wherein the client device is used to display the information related to the agricultural condition of the parcel of land, and wherein the client device displays the information in a graphical user interface including an image of the parcel of land and at least one graphical card.

In another aspect, the subject matter of this disclosure relates to a system having one or more computer systems programmed to perform operations including: providing a platform to a plurality of publishers and a plurality of subscribers, the plurality of publishers including one or more entities that provide data to the platform related to agricultural fields, the plurality of subscribers including one or more users who receive data from the platform related to the agricultural fields; receiving, from the plurality of publishers, publisher data including at least one of satellite image data, weather data, laboratory data, or sensor data for the agricultural fields; receiving, from a subscriber in the plurality of subscribers, a definition of a parcel of land in the agricultural fields; processing the publisher data to generate information related to a condition of the parcel of land in the agricultural fields; and providing, to the subscriber, the information related to the condition of the parcel of land in the agricultural fields.

In various examples, the one or more entities can include a satellite image provider, a weather data provider, a laboratory data provider, and/or a sensor. The one or more users can access the platform using one or more respective client devices. The definition of the parcel of land can include a definition of a boundary for the parcel of land. The satellite image data can include satellite images having color and near infrared information. The weather data can include current weather conditions and/or predicted weather conditions. The sensor data can be obtained from at least one Internet of things device installed in the agricultural fields.

In some instances, processing the publisher data can include: calculating a normalized difference vegetation index (NDVI) from a satellite image of the parcel of land; and modifying the satellite image to include colors representing the NDVI values in the parcel of land. Providing the information can include providing the modified satellite image for presentation on a client device of the subscriber. Providing the information can include providing the information to a client device of the subscriber, wherein the client device is used to display the information related to the agricultural condition of the parcel of land, and wherein the client device displays the information in a graphical user interface including an image of the parcel of land and at least one graphical card.

In another aspect, the subject matter of this disclosure relates to a non-transitory computer-readable medium having instructions stored thereon that, when executed by one or more computer processors, cause the one or more computer processors to perform operations including: providing a platform to a plurality of publishers and a plurality of subscribers, the plurality of publishers including one or more entities that provide data to the platform related to agricultural fields, the plurality of subscribers including one or more users who receive data from the platform related to the agricultural fields; receiving, from the plurality of publishers, publisher data including at least one of satellite image data, weather data, laboratory data, or sensor data for the agricultural fields; receiving, from a subscriber in the plurality of subscribers, a definition of a parcel of land in the agricultural fields; processing the publisher data to generate information related to a condition of the parcel of land in the agricultural fields; and providing, to the subscriber, the information related to the condition of the parcel of land in the agricultural fields.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is schematic diagram of a system for distributing agricultural information from a plurality of publishers to a plurality of subscribers, in accordance with certain embodiments;

FIG. 2 includes an image of a mobile device displaying information related to an agricultural field, in accordance with certain embodiments;

FIG. 3 includes an image of a mobile devices displaying information related to an agricultural field, in accordance with certain embodiments;

FIG. 4 includes a satellite image of a plurality of agricultural fields, in accordance with certain embodiments;

FIG. 5 is a schematic block diagram of a system for enabling a subscriber to receive data from a publisher, in accordance with certain embodiments.

FIG. 6 is a schematic block diagram of a system for performing a request-response cycle, in accordance with certain embodiments;

FIG. 7 is a flowchart of a computer-implemented method of providing data from publishers to subscribers, in accordance with certain embodiments; and

FIG. 8 is a schematic block diagram of a computer system, in accordance with certain embodiments.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

In general, the subject matter of this disclosure relates to systems and methods that enable growers, farmers, or other individuals to obtain data related to conditions in agricultural fields, such as vineyards. The systems and methods can enable a grower to access field-level data from anywhere at any time, with or without an Internet connection. Such data can keep the grower apprised of conditions in the fields and can help the grower manage field operations and take corrective action, when needed. Beyond growers, the present systems and methods support an ecosystem of users, partners, collaborators, and producers who contribute to the agriculture industry.

In general, prior agriculture systems for providing field data come from many suppliers and/or service providers that are not integrated and/or exist independently from one another. The disparate agricultural technology services have unique requirements that do not lend themselves well to current integration solutions. Such requirements can include, for example, a need to accommodate growers and other users who (i) often have poor cellular connectivity, (ii) are highly mobile (e.g., not in an office), (iii) are typically outside, and/or (iii) are not skilled in computer technology. Such users generally require simple tools and devices that provide information, request information, and/or have bi-directional functionality requirements. Unlike a content streamer, agricultural technologies can require both dispersal of insight and information as well as collection of information in field to provide relevant feedback and instruction to the publishing services.

In various examples, the present systems and methods can aggregate data from multiple sources to display information to growers for agricultural decision-making and communication. The present systems and methods can provide: data pipelines to retrieve data from external sources; application programming interfaces (APIs) to normalize data transferred to a mobile application (or put such data in a desired format); offline storage on mobile devices to allow access when cellular connectivity is poor or missing; and/or visualization of data and insights (e.g., as defined through metadata) for data pulled from external sources. As described herein, the systems and methods can provide users with various functionalities, including, for example: map views showing an agricultural field and one or more conditions in and around the field; text and chart views presented in a card format; alerts and notifications; and/or an ability to record data through user mobile devices.

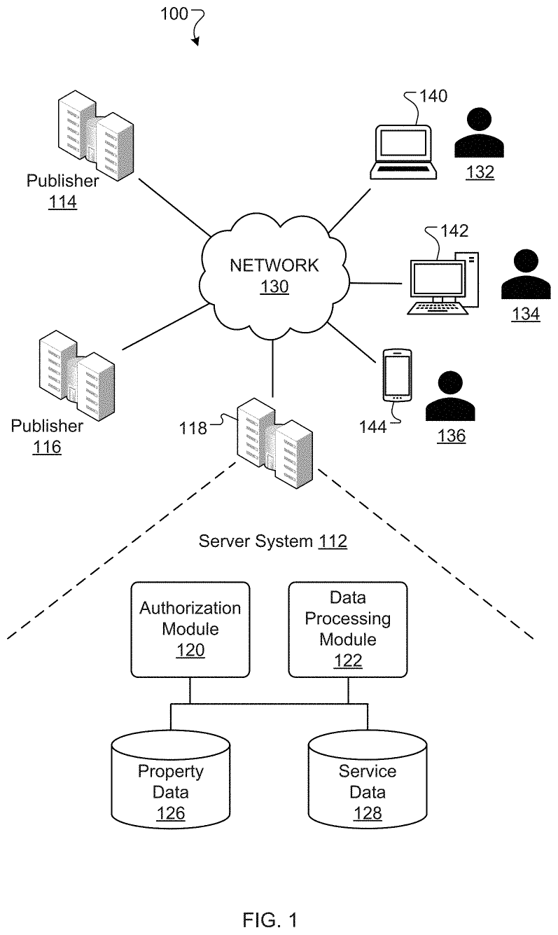

FIG. 1 illustrates an example system 100 for providing growers, farmers, and other individuals with data related to conditions in agricultural fields. A server system 112 provides functionality for receiving data from a plurality of publishers, including a first publisher 114 and a second publisher 116. The publishers 114 and 116 can provide the system 100 with information related to conditions in the agricultural fields. Such information can be or include information related to, for example, satellite imagery (e.g., from ESA SENTINEL or LANDSAT), weather conditions (e.g., from DARK SKY), laboratory data (e.g., from a laboratory or laboratory information management system), soil conditions, fruit conditions, moisture levels, pest detection, and the like. Any number of publishers can be included in the system 100. In some examples, the publishers 114 and/or 116 can be or include one or more organizations or companies that provide cloud-based or online services and can utilize one or more server computers to provide such services. Additionally or alternatively, the publishers 114 and/or 116 can be or include one or more IoT devices, such as, for example, a sensor (e.g., for detecting soil conditions, fruit sizes, moisture levels, etc.), a camera, or other device installed in or around an agricultural field. Data pipelines can be provided to support information exchanges with the publishers 114 and 116.

The server system 112 (alternatively referred to herein as a platform) includes software components and databases that can be deployed at one or more data centers 118 in one or more geographic locations, for example. In certain instances, the server system 112 is, includes, or utilizes a content delivery network (CDN). The server system 112 software components can include an authorization module 120 and a data processing module 122. The authorization module 120 can be used to confirm that publishers and/or users (alternatively referred to herein as subscribers) of the system 100 have appropriate access to send or receive information to or from the system 100. For example, the authorization module 120 can be used to confirm that users of the system 100 are authorized to receive information before the information is provided to the users. The data processing module 122 can be used to process data received from the publishers and/or users. For example, the data processing module 122 can receive raw data from the publishers 114 and 116 and process the raw data into a form that is more easily digestible by the users. In some instances, for example, the processing module 122 can generate images, tables, graphs, and/or charts that can be displayed on client devices (e.g., mobile devices) for the users. The software components can include subcomponents that can execute on the same or on different individual processors or data processing apparatus.

The server system 112 databases can include a property data 126 database and a service data 128 database. The property data 126 database can store data related to properties owned or managed by the users. Such data can be provided by users of the system 100 and/or can include, for example, definitions of boundaries defining agricultural fields, geographical locations for agricultural fields, information related to plants being grown in the fields (e.g., types of plants, ages of plants, plant or row spacing, etc.), and/or other characteristics associated with the fields. The service data 128 database can store information related to agricultural fields that is provided by the publishers 114 and 116. Such information can include, for example, satellite images, weather conditions (e.g., past, present, and/or future), soil conditions, moisture levels, etc. The property data 126 database and the service data 128 database can reside in one or more physical storage systems. The software components and data will be further described below.

A software application, such as, for example, a client-based application and/or web-based software application, can be provided as an end-user application to allow users to interact with the server system 112. The software application can relate to and/or provide a wide variety of functions and information related to agriculture, including, for example, current agricultural field conditions, images of agricultural fields, weather information, plant information, etc. Users can use the software application to obtain and/or provide information related to agriculture fields, as described herein.

The publishers 114 and 116 and the users can access the system 100 through a network 130, which can be or include the Internet. In the depicted example, three users 132, 134, and 136 access the system 100 using client devices 140, 142, and 144, respectively. Any number of users and/or respective client devices can be included. The client devices can be or include, for example, one or more mobile devices, smart phones, tablet computers, laptop computers, and/or desktop computers. In some examples, the property data 126 database, the service data 128 database, or any portions thereof can be stored on one or more client devices and/or in databases associated with the publishers 114 and 116. Such local databases can allow users to access information provided by the system 100 when no network connection is available. For example, the information can be downloaded to and stored on a mobile device when a network connection is available, and the information can be accessed later by a user even when no network connection is available. Additionally or alternatively, software components for the system 100 (e.g., the authorization module 120 and/or the data processing module 122) or any portions thereof can reside on or be used to perform operations on one or more client devices and/or by the publishers 114 and 116.

Advantageously, to address problems associated with prior approaches, the system 100 provides a platform that allows growers and other users to access data or solutions from a variety of publishers, including IoT devices and third party services. The system 100 can provide users with crop health imagery, irrigation scheduling, pest detection, work scheduling, equipment maintenance, and/or other information or services related to agricultural operations. The system 100 provides a platform where IoT providers and service vendors can provide their products and services, and users can access the products and services from a single location (e.g., on their mobile devices, using a single application).

According to one embodiment, the system 100 allows a grower to determine when field level changes occur (or will occur) that have an impact on a quality or yield of the grower's crop. Alerts or notifications can be provided to inform the grower that immediate action should be taken to improve plant health or avoid plant damage. Further, data related to crops in the field can be used to facilitate transportation of a harvest and/or help with a supply chain from the field to the consumer or customer.

In various examples, the system 100 can provide users with a view of crop health based on a normalized difference vegetation index (NDVI). NDVI can be calculated from digital images or photographs, such as satellite images or drone images. In some examples, NDVI can be calculated from

$$NDVI = \frac{NIR - RED}{NIR + RED} , \qquad ( 1 )$$

where NIR is reflection (e.g., light intensity) in a near-infrared spectrum and RED is reflection in a red range of a visible light spectrum. Equation (1) produces NDVI values that range from −1 to 1. In general, NDVI can provide an indication of plant health, with higher NDVI values being associated with healthy plants and lower NDI values being associated with unhealthy plants. Compared to healthy plants, unhealthy plants tend to reflect more red light, which results in higher values for RED and lower values for NDVI, as calculated by equation (1). In some examples, NDVI can be calculated for each pixel in an image.

To make NDVI values more easily digestible by users of the system, the calculated NDVI values can be converted into corresponding colors and displayed on a map. The colors in the map can provide users with an easy identification of any portions of a field where plants may be stressed and/or require attention. The colors displayed in the map can be correlated to whether or not action is required by the users. For example, red or orange colors can be used to identify locations in the field where plants are stressed and require immediate attention. Similarly, green or yellow colors can be used to identify locations in the field where plants are healthy and do not require any immediate attention. Color coding maps according to NDVI in this manner can be more helpful than using colors to merely identify variations in NDVI. For example, even when NDVI varies considerably within a field, all portions of the field may be healthy, such that no action is required by the users. Presenting users with colors that emphasize NDVI variations can therefore cause users to focus on areas of the field where plants are doing well and do not require any attention. In general, variations in NDVI do not necessarily indicate action is required, because areas with healthy plants can exhibit large differences in NDVI values. It can be more important to focus on NDVI values that fall below a specified threshold. Such values can be given a different color (e.g., red or orange) compared to colors used for other NDVI values. This can allow users to more easily identify actual problem areas on the map.

In some implementations, color-coded maps of crop health can be generated from color images (e.g., satellite images or drone images) having multiple color layers, including an NIR layer and a RED layer. The images can be obtained from a publisher (e.g., the publisher 114 or 116), which can be or include, for example, an owner or distributor of the images (e.g., ESA SENTINEL, LANDSAT, or a drone photography business). NDVI calculations can then be performed from NIR and RED pixel values in the images. For a given image, a standard deviation σ and a mean x̅ (or average) for NDVI can be determined for data points (e.g., pixels) across each field or collection of fields (e.g., a ranch having a geographic collection of fields). The colors used to represent NDVI values for the pixels can then be determined according to the standard deviation σ and the mean x̅ for the NDVI values. For example, a plurality of bins can be defined based on the standard deviation σ and the mean x̅, and each pixel can be assigned a color according to its respective bin. The bin boundaries can be as follows: x̅−3σ, x̅−2.5σ, x̅−2σ, x̅−1σ, x̅+1σ, x̅+2σ, and x̅+2.5σ. Colors ranging from red to yellow to green can be used to indicate relative plant health. For example, NDVI values that are less than or equal to x̅−3σ can be assigned to deep red, and NDVI values that are greater than x̅−3σ and less than or equal to x̅−2.5σ can be assigned to red. Likewise, NDVI values are greater than x̅+3σ can be assigned to deep green. Table 1 indicates a color coding scheme that can be used to generate an image or map of a field according to NDVI values, in accordance with certain examples.

TABLE 1
Color coding scheme for presenting NDVI values.

| NDVI Value | Color |
|---|---|
| NDVI ≤ x̅ − 3σ | Dark Red |
| x̅ − 3σ < NDVI ≤ x̅ − 2.5σ | Red |
| x̅ − 2.5σ < NDVI ≤ x̅ − 2σ | Dark Orange |
| x̅ − 2σ < NDVI ≤ x̅ − 1σ | Orange |
| x̅ − 1σ < NDVI ≤ x̅ + 1σ | Yellow |
| x̅ + 1σ < NDVI ≤ x̅ + 2σ | Yellow-Green |
| x̅ + 2σ < NDVI ≤ x̅ + 2.5σ | Green |
| x̅ + 2.5σ < NDVI | Dark Green |

Additionally or alternatively, in some examples, a distribution of NDVI values across an entire ranch or field can be determined. Each pixel in the map can be given a rating of between 1 and 8 (e.g., 1 is dead and 8 is overly vigorous) based on the pixel's NDVI value in the distribution of NDVI values (e.g., according to the bin boundaries described above). Colors can then be applied to each pixel according to the ratings. For example, a pixel having a rating of 1 can be colored dark red, a pixel having a rating of 4 can be colored orange, and a pixel having a rating of 8 can be colored dark green. In some instances, NDVI values or related images for a field can be compared over time (e.g., week over week) to monitor trends. Alerts can be sent to users when problems related to NDVI or other variables (e.g., moisture levels, pests, etc.) arise. For example, an alert can indicate that a problem (e.g., a disease) exists in a particular field location. The alert can provide a user with a recommended solution to the problem (e.g., apply a specific product or material).

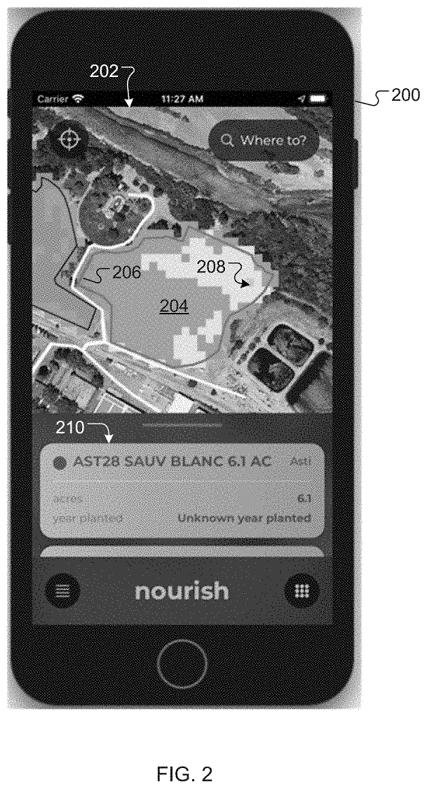

FIG. 2 is an image of a mobile device 200 presenting a map 202 (e.g., based on a satellite image) that has been color-coded according to NDVI calculations, as described herein. The map shows an agricultural field 204 defined by a boundary 206. Pixels within the field 204 are color-coded to indicate where plant health is good or acceptable (e.g., green colors) and where plant health is not acceptable (e.g., orange or red colors). A user of the mobile device 200 can view the map 202 and, based on the colors, determine whether any plants in the field are unhealthy and require attention. The map 202 can inform the user where such plants are located in the field, and the user can then visit the plants and take any necessary corrective action (e.g., provide water, apply fertilizer, and/or apply a pesticide or herbicide). The map 202 in this example indicates that one portion 208 of the field 204 is orange and may require attention. The remaining portions of the field 204 are either green or yellow, which can indicate the plants are healthy in those portions.

In addition to the map 202, the mobile device 200 can display tables, charts, or graphs that present information related to the field 204 and/or conditions around the field 204. For example, an information card 210 can be displayed that presents information about a size of the field 204, a type of plant growing in the field 204, and/or an age of the plants in the field 204 (e.g., a year a crop was planted).

In various examples, the mobile device 200 can display the map 202, the information card 210, and other information related to the field 204 or other fields regardless of whether or not the mobile device presently has a network connection (e.g., a cell phone connection, a Wi-Fi connection, or other connection to the Internet). In some instances, for example, the mobile device 200 can download the information related to the fields when a network connection is available. Such downloads can occur automatically when a network connection is established and/or at regular intervals. For example, a software application running on the mobile device 200 can be programmed to periodically determine if a network connection is available and, if so, download any updates to the information. Additionally or alternatively, the software application can be programmed to look for and download updates at specific times of day (e.g., early morning, evening, or middle of the night). By downloading and storing the information on the mobile device 200, the user can access the information (e.g., the map 202 and the information card 210) even when working in remote locations with no network connection or Internet access.

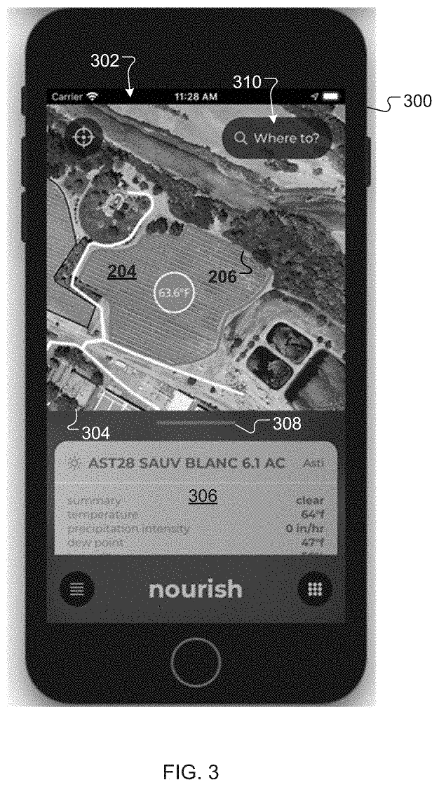

FIG. 3 is an image of a mobile device 300 displaying a graphical user interface 302 that includes a map 304 (e.g., based on a satellite image) and an information card 306. The map 304 shows the agricultural field 204 defined by the boundary 206. A brief description (e.g., a name) of the agricultural field 204, a type of plant being grown in the agricultural field 204, and/or weather conditions (e.g., current or predicted) for the agricultural field 204 can be presented on the map 304 and/or in the information card 306. For example, a current temperature can presented on the map 304 as a numerical value and/or weather conditions (e.g., temperature, dew point, cloud cover, and/or a precipitation history or forecast) can be presented in the information card 306. The information card 306 can include a handle 308 that the user can select and move up or down, to make the card more or less visible in the graphical user interface 302. For example, a user can place a finger on the handle 308 and slide the finger up along a display of the mobile device 300, to move the handle upward and show more of the information card 306 and less of the map 304. In some implementations, additional information cards (not shown) can be accessed or presented, for example, when the user performs additional upward swipes or other movements of a finger along the display. The additional information cards can present additional information related to the agricultural field 204, such as soil conditions, recommended or scheduled action items, or messages for the agricultural field 204. The user can move the handle downward to show less of the information card 306 and more of the map 304. The depicted graphical user interface 302 includes a search field 310 that allows the user to search for other agricultural fields of interest. For example, the user can enter a name or address of a different field and the graphical user interface 302 can search for and present a corresponding map and/or information card for the different field. In general, the graphical user interface 302 can be used to present information obtained from a plurality of publishers, as described herein.

In various examples, an application running on a mobile device (e.g., the mobile device 300) can collect information related to agricultural fields from the user, such as a grower, farmer, or field worker. The data collected from the user can be organization specific. For example, administrators and/or growers may define one or more templates for field observations that should be collected and one or more attributes that should be collected for each observation. In some instances, for example, an organization (e.g., a business that owns or manages multiple agricultural fields) can create a pest observation template (e.g., having data entry fields) that allows users to enter information related to pest infestations. For example, a user can specify a type of pest, how the pest was sampled, and/or a pest infection rate for an agricultural field. Additionally or alternatively, a soil sample observation template can be created that allows a user to input sample numbers, crust level, moisture level, and/or other information related to soil samples.

In some examples, the application allows users to enter information related to specific tasks that are or were performed by the users. For example, a grower can enter information describing the introduction of plants to a field (e.g., date of planting and type of plants), the application of materials to a field (e.g., water, fertilizer, and/or pesticides, and respective dates of application), and/or the removal of materials removed from the field (e.g., harvested produce and dates of harvest). Users can use the application to enter such information on their mobile devices when working in and around the agricultural fields. If no network connection is available, the user can enter the information in the application and the information can be uploaded (e.g., to the server system 112) later, for example, when a network connection is or becomes available.

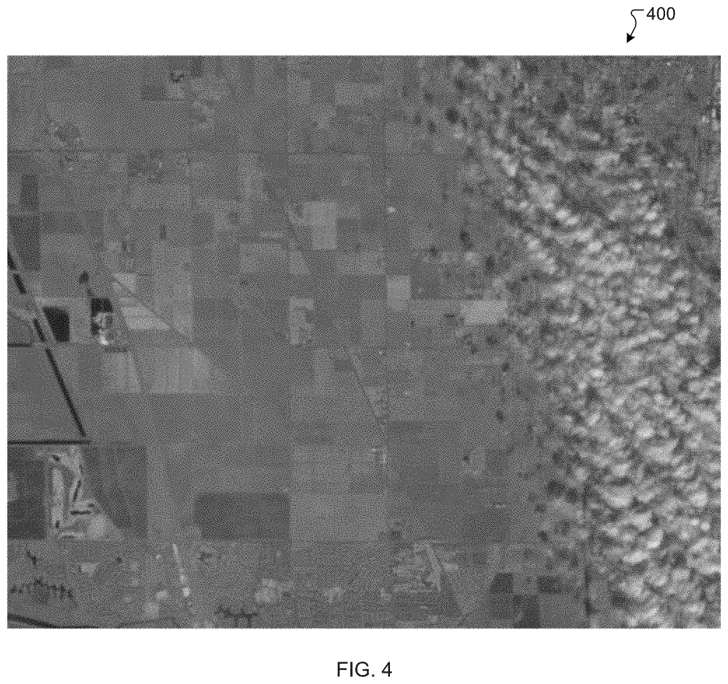

FIG. 4 includes a satellite image 400 of a plurality of agricultural fields, in accordance with certain examples. To perform NDVI calculations, the image 400 can include or be separated into individual color layers (e.g., including a red layer and a near infrared layer). Cloud masking can be performed to ignore or compensate for areas blocked by cloud cover. Each pixel in the image 400 can cover or correspond to an area on the ground of about 30 meters×30 meters, about 10 meters×10 meters, or smaller. Different image resolutions or pixel sizes may be desirable in certain instances, for example, depending on precision requirements and/or data storage limitations.

Referring again to FIG. 1, in certain implementations, the server system 112 can pull in data from publishers (e.g., using the publishers' application programming interfaces or APIs), process data, store data, and/or share data with one or more users. A variety of data structures or presentation formats can be used to share the data with users, such as, for example: features or map view data (e.g., images); alerts or notifications (e.g., text messages or email messages related to items that require grower action or attention); observations or point in time and place data; and/or cards or informational data. The mobile application, which runs on the mobile devices (e.g., the client device 144), can retrieve data from the server system 112 (e.g., without regard to the publisher or source) and present the data to users. In general, core data (e.g., indicating where fields are located on a map) can be maintained internally in the database (e.g., stored on the mobile device and/or in the property data 126 database) and publisher data or third party data can be retrieved as needed, for example, during a sync process involving the server system 112 and the mobile devices. For example, the server system 112 and/or mobile devices may not store weather data, but can instead pull such data when needed (e.g., when loading a mobile user's cache on a mobile phone). Additionally or alternatively, a mobile device can store data that a user may need to access when no network connection is available, such as data for maps, data for information cards, data entered by users, and/or data related to previous alerts. The mobile device can store metadata describing how such data (e.g., maps, information cards, and data entry screens) should be presented in the application.

The server system 112 can be responsible for brokering requests to correct sources, such as retrieving information from a specific publisher and providing the information to a specific subscriber. In some examples, the server system 112 can utilize a publish-subscribe architecture in which publisher data is published to one or more channels (e.g., corresponding to weather, images, and/or laboratory data), and one or more subscribers can access the data by subscribing to the one or more channels.

In various examples, the server system 112 can constrain how data is provided to individual users according to various parameters, such as, for example, a user's geographical location, a data subscription for the user, and/or the user's role in an organization. For example, the mobile device of a user may store information related to fields that are within a certain distance of the user (e.g., 100 miles, 50 miles, or less). Information for other fields can be downloaded to the mobile device when the user moves closer to those fields and/or when the user requests such information. In some instances, a mobile device may be able to access information according to a subscription plan. For example, a mobile device may subscribe to a weather service and may be able to access weather data but may not subscribe to a satellite image service and therefore may be unable to access satellite images. Additionally or alternatively, users within an organization may have access to different information provided by the server system 112. For example, a mobile device of a grower may have access to data related to agricultural field conditions but not have access to certain financial or business records associated with the field. The server system 112 can enable users to download additional data, if needed (e.g., upon request or based on extraordinary use), when an online connection is available. Users may not need to take any additional steps (e.g., request authorization) to download or access such additional data.

In various examples, the platform described herein (e.g., the server system 112) can act as a configurable data broker for sharing temporal and geospatial data products on-demand between publishers and subscribers. The platform can allow publishers to focus on creating global-scale data layers without having to cater to specific customers or create custom software interfaces to distribute the publisher's data. Subscribers can have the benefit of being able to view related yet distinct datasets in a single software application.

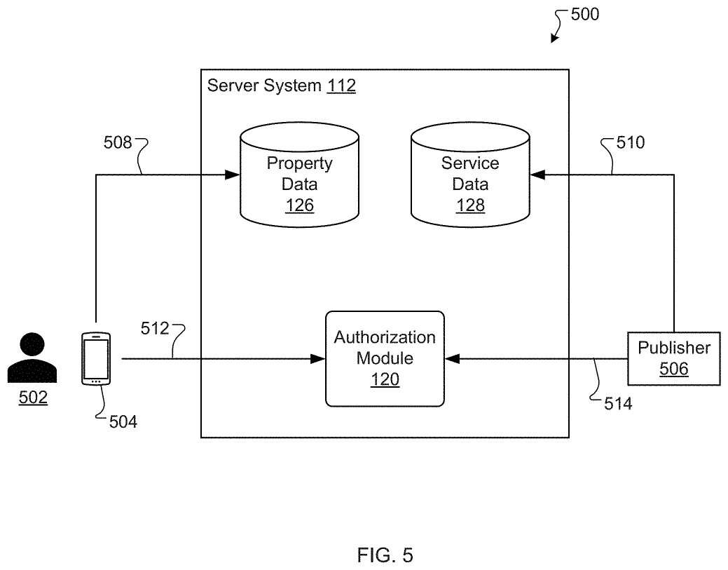

For example, FIG. 5 is a block diagram of a system 500 for enabling a subscriber 502 to receive data from a publisher 506, according to certain examples. The subscriber 502 can use a client device 504 to define boundaries of a property or field on a world map. The field can be defined using a standard format, such as GeoJSON with WGS84 coordinates. The field definition can serve as a target area for an available data product and can be stored (step 508) in the property data 126 database of the server system 112. The publisher 506 can define the publisher's service, for example, by specifying geographic regions where the service is available, a frequency of updates, and/or a template for data (e.g., data formats) that the client device 504 may receive. The template can be in a structured data format, such as, for example, GraphQL or Protocol Buffers (e.g., Protobuf). The service definitions can be stored (step 510) in the service data 128 database. Next, the subscriber 502 can use the client device 504 to define one or more services (e.g., weather, NDVI calculations, aerial images, notifications, etc.) to which the subscriber 502 wants to subscribe and/or to specify one or more fields for the subscription and/or other subscribers who should be given access to the one or more services. Requests for services received (step 512) from the subscriber 502 and responses received (step 514) from the publisher 506 may be exchanged or take place in an online “marketplace” interface and/or can utilize an administration console (e.g., provided by the authorization module 120) that allows the server system 112 and/or publisher 506 to grant the subscriber 502 access to services and/or revoke access to the services (e.g., on demand). The publisher 506 can configure privacy settings and accept or reject subscriptions at any time so that the publisher 506 is able to maintain control over who uses the publisher's data. Authorization of access to services can be subject to contractual agreements and/or payments between the publisher 506 and the subscriber 502.

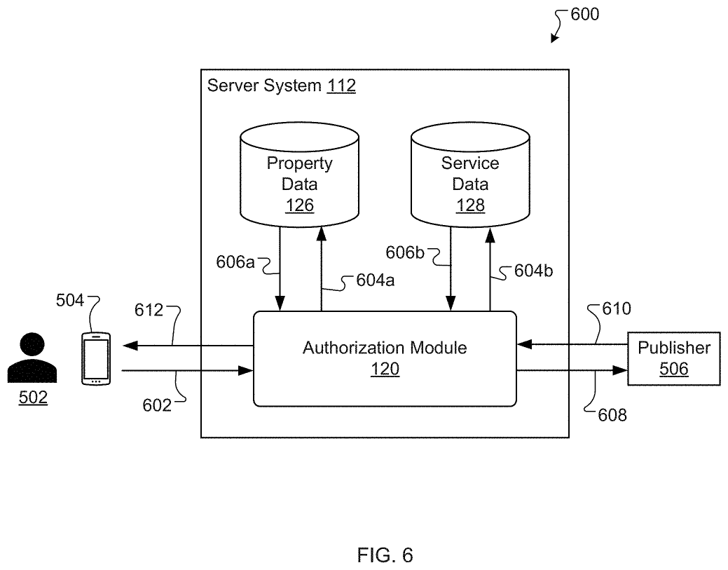

FIG. 6 is a block diagram of a system 600 for performing a request-response cycle, according to certain examples. The subscriber 502 uses the client device 504 to initiate (step 602) a request for data related to the subscriber's property, which can be or include one or more agricultural fields. The request can be or include, for example, a standard HTTP GET request that contains a geometry identifier and/or service identifier, given that geometries and services can already be defined within the server system 112 (e.g., in the property data 126 database and the service data 128 database). The server system 112 can ensure that the user is authorized to access information for the associated geometry and service and can request (steps 604a and 604b) and receive (steps 606a and 606b) data from the property data 126 database and/or the service data 128 database.

In some examples, the server system 112 can validate the geometry and service definitions, for example, to confirm that the requested service is available in the location of the defined geometry and/or that the subscriber 502 is authorized to receive data from the publisher 506. The server system 112 can initiate a request (step 608) to the publisher 506 on behalf of the subscriber 502 that contains the subscriber's predefined geometry. The request from the publisher 506 may be or include an HTTP request or can utilize remote procedure call (RPC) or other network protocol. In response, the publisher 506 can perform computation or database retrieval to produce the requested data (e.g., images or weather data) and send (step 610) the data back to the server system 112. The server system 112 can confirm or validate that the data conforms to a desired template or data format. The data and/or the template can be sent (step 612) to the client device 504 or a software application running on the client device 504. The template can be used to generate a graphical user interface that displays the data for the subscriber 502.

In certain implementations, the platform described herein (e.g., the server system 112) can provide users with access to a publishing service that maintains gigapixel-size satellite images of vegetation for the state of California or other geographic regions. The large images can span 100×100 km areas and/or can be stored irrespective of agricultural field geometries. The images can be cropped and retrieved on-demand as new field geometries are added and removed. The platform can be used to provide subscribers with data available from a wide variety of publishers. In addition to satellite images, the publisher data can be or include, for example, drone images, weather data, soil data, maintenance data, and/or data from IoT-scale sensor installations. Advantageously, the platform can enable the brokering of data products between publishers and subscribers without the overhead of creating new software interfaces for each individual product or type of data provided by the publishers.

In certain examples, publishers can make data available for consumption by subscribers, which can be or include a mobile application, a web application, a client device, and/or users of the mobile application, the web application, or the client device. A subscriber makes a request for data to the platform (e.g., the server system 112), and the platform can act as a broker to decide which publishers supply the data and/or can pull the data from the publishers. The platform can respond with data formatted as the subscriber expects. The data can be displayed in the form of maps, information cards, or other presentation formats.

In addition to providing information to subscribers, as described herein, the platform can also allow subscribers to initiate or control certain activities related to agricultural fields. For example, when a grower learns that moisture levels in a field are low, the grower can use the platform (or a software application associated with the platform) to initiate an irrigation sequence for the field. In response to instructions from the grower, the platform can send a signal to an irrigation system or component thereof (e.g., a pump) to irrigate the field. Additionally or alternatively, the grower can use the platform to request and receive data from one or more sensors or cameras installed in or around the field, as needed.

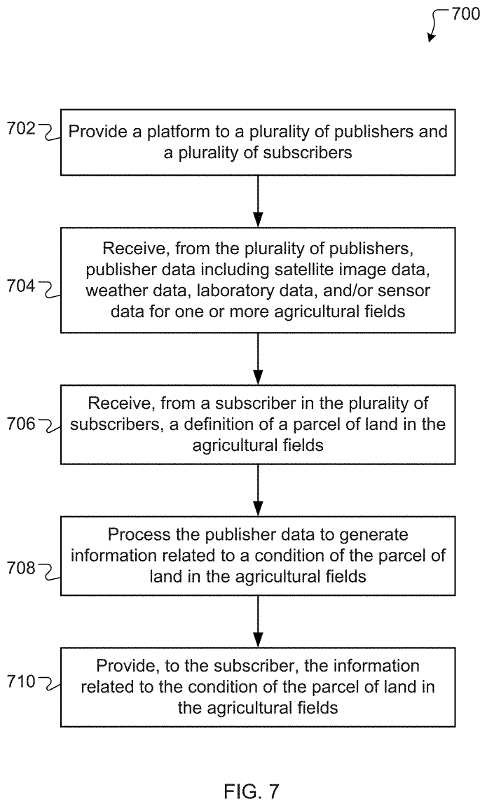

FIG. 7 is a flowchart of a computer-implemented method 700 of providing data from publishers to subscribers, in accordance with certain examples. A platform is provided (step 702) to a plurality of publishers and a plurality of subscribers. The plurality of publishers include one or more entities that provide the platform with data relating to agricultural fields. The plurality of subscribers include one or more users (and/or user devices or software applications) who receive data from the platform related to the agricultural fields. Publisher data including satellite image data, weather data, laboratory data, and/or sensor data for the agricultural fields is received (step 704) from the plurality of publishers. A definition of a parcel of land in the agricultural fields is received (step 706) from a subscriber in the plurality of subscribers. The publisher data is processed (step 708) to generate information related to a condition of the parcel of land in the agricultural fields. The information related to the condition of the parcel of land in the agricultural fields is provided (step 710) to the subscriber.

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used and/or functional programming languages can be used. Electrical memory, such as flash-based memory, can be used.

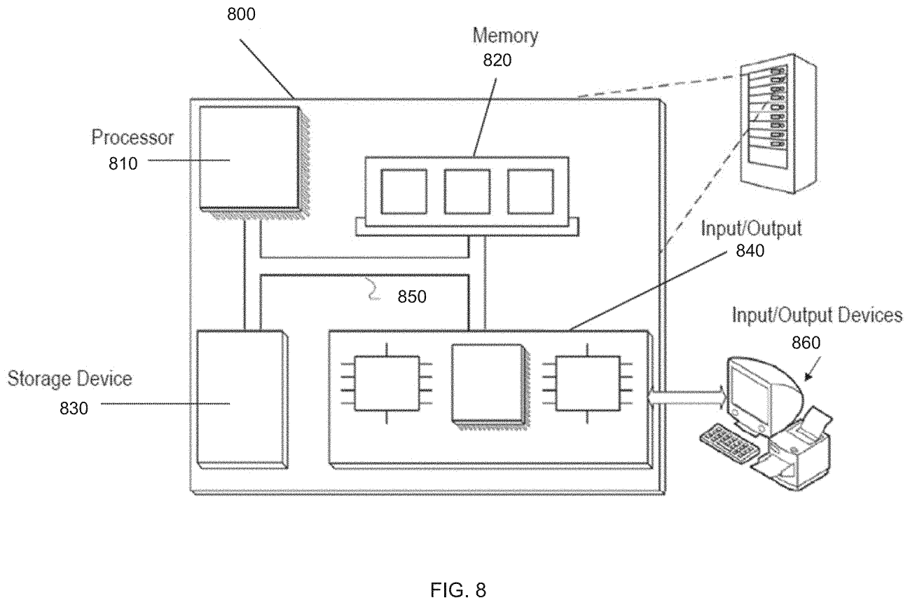

FIG. 8 is a block diagram of an example computer system 800 that may be used in implementing the technology described in this document. General-purpose computers, network appliances, mobile devices, or other electronic systems may also include at least portions of the system 800. The system 800 includes a processor 810, a memory 820, a storage device 830, and an input/output device 840. Each of the components 810, 820, 830, and 840 may be interconnected, for example, using a system bus 850. The processor 810 is capable of processing instructions for execution within the system 800. In some implementations, the processor 810 is a single-threaded processor. In some implementations, the processor 810 is a multi-threaded processor. The processor 810 is capable of processing instructions stored in the memory 820 or on the storage device 830.

The memory 820 stores information within the system 800. In some implementations, the memory 820 is a non-transitory computer-readable medium. In some implementations, the memory 820 is a volatile memory unit. In some implementations, the memory 820 is a non-volatile memory unit.

The storage device 830 is capable of providing mass storage for the system 800. In some implementations, the storage device 830 is a non-transitory computer-readable medium. In various different implementations, the storage device 830 may include, for example, a hard disk device, an optical disk device, a solid-date drive, a flash drive, or some other large capacity storage device. For example, the storage device may store long-term data (e.g., database data, file system data, etc.). The input/output device 840 provides input/output operations for the system 800. In some implementations, the input/output device 840 may include one or more of a network interface devices, e.g., an Ethernet card, a serial communication device, e.g., an RS-232 port, and/or a wireless interface device, e.g., an 802.11 card, a wireless modem (e.g., 3G, 4G, or 5G). In some implementations, the input/output device may include driver devices configured to receive input data and send output data to other input/output devices, e.g., keyboard, printer and display devices 860. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 830 may be implemented in a distributed way over a network, for example as a server farm or a set of widely distributed servers, or may be implemented in a single computing device.

Although an example processing system has been described in FIG. 8, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, an engine, a pipeline, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method comprising:
providing a platform to a plurality of publishers and a plurality of subscribers, the plurality of publishers comprising one or more entities that provide data to the platform related to agricultural fields, the plurality of subscribers comprising one or more users who receive data from the platform related to the agricultural fields;
receiving, from the plurality of publishers, publisher data comprising at least one of satellite image data, weather data, laboratory data, or sensor data for the agricultural fields;
receiving, from a subscriber in the plurality of subscribers, a definition of a parcel of land in the agricultural fields;
processing the publisher data to generate information related to a condition of the parcel of land in the agricultural fields; and
providing, to the subscriber, the information related to the condition of the parcel of land in the agricultural fields.

2. The method of claim 1, wherein the one or more entities comprise at least one of a satellite image provider, a weather data provider, a laboratory data provider, or a sensor.

3. The method of claim 1, wherein the one or more users access the platform using one or more respective client devices.

4. The method of claim 1, wherein the definition of the parcel of land comprises a definition of a boundary for the parcel of land.

5. The method of claim 1, wherein the satellite image data comprise satellite images having color and near infrared information.

6. The method of claim 1, wherein the weather data comprises at least one of current weather conditions or predicted weather conditions.

7. The method of claim 1, wherein the sensor data is obtained from at least one Internet of things device installed in the agricultural fields.

8. The method of claim 1, wherein processing the publisher data comprises:
calculating a normalized difference vegetation index (NDVI) from a satellite image of the parcel of land; and
modifying the satellite image to include colors representing the NDVI values in the parcel of land.

9. The method of claim 8, wherein providing the information comprises providing the modified satellite image for presentation on a client device of the subscriber.

10. The method of claim 1, wherein providing the information comprises providing the information to a client device of the subscriber, wherein the client device is used to display the information related to the agricultural condition of the parcel of land, and wherein the client device displays the information in a graphical user interface comprising an image of the parcel of land and at least one graphical card.

11. A system comprising:
one or more computer systems programmed to perform operations comprising:
providing a platform to a plurality of publishers and a plurality of subscribers, the plurality of publishers comprising one or more entities that provide data to the platform related to agricultural fields, the plurality of subscribers comprising one or more users who receive data from the platform related to the agricultural fields;
receiving, from the plurality of publishers, publisher data comprising at least one of satellite image data, weather data, laboratory data, or sensor data for the agricultural fields;
receiving, from a subscriber in the plurality of subscribers, a definition of a parcel of land in the agricultural fields;
processing the publisher data to generate information related to a condition of the parcel of land in the agricultural fields; and
providing, to the subscriber, the information related to the condition of the parcel of land in the agricultural fields.

12. The system of claim 11, wherein the one or more entities comprise at least one of a satellite image provider, a weather data provider, a laboratory data provider, or a sensor.

13. The system of claim 11, wherein the definition of the parcel of land comprises a definition of a boundary for the parcel of land.

14. The system of claim 11, wherein the satellite image data comprise satellite images having color and near infrared information.

15. The system of claim 11, wherein the weather data comprises at least one of current weather conditions or predicted weather conditions.

16. The system of claim 11, wherein the sensor data is obtained from at least one Internet of things device installed in the agricultural fields.

17. The system of claim 11, wherein processing the publisher data comprises:
calculating a normalized difference vegetation index (NDVI) from a satellite image of the parcel of land; and
modifying the satellite image to include colors representing the NDVI values in the parcel of land.

18. The system of claim 17, wherein providing the information comprises providing the modified satellite image for presentation on a client device of the subscriber.

19. The system of claim 11, wherein providing the information comprises providing the information to a client device of the subscriber, wherein the client device is used to display the information related to the agricultural condition of the parcel of land, and wherein the client device displays the information in a graphical user interface comprising an image of the parcel of land and at least one graphical card.

20. A non-transitory computer-readable medium having instructions stored thereon that, when executed by one or more computer processors, cause the one or more computer processors to perform operations comprising:
providing a platform to a plurality of publishers and a plurality of subscribers, the plurality of publishers comprising one or more entities that provide data to the platform related to agricultural fields, the plurality of subscribers comprising one or more users who receive data from the platform related to the agricultural fields;
receiving, from the plurality of publishers, publisher data comprising at least one of satellite image data, weather data, laboratory data, or sensor data for the agricultural fields;
receiving, from a subscriber in the plurality of subscribers, a definition of a parcel of land in the agricultural fields;
processing the publisher data to generate information related to a condition of the parcel of land in the agricultural fields; and
providing, to the subscriber, the information related to the condition of the parcel of land in the agricultural fields.
